(19) United States
(12) Patent Application Publication
(10) Pub. No.: US 2008/0303959 A1
(43) Pub. Date: Dec. 11, 2008

(54) Method and Apparatus for Changing Channels in a System Operating in a Recording Mode

(76) Inventors: Mark Gilmore Mears, Zionsville, IN (US); James Duane Tenbarge, Fishers, IN (US); Bret David Hawkins, Brownsburg, IN (US); Chad Andrew Lefevre, Indianapolis, IN (US)

Correspondence Address: Joseph J. Laks;Thomson Licensing LLC, 2 Independence Way, Patent Operations, PO Box 5312, PRINCETON, NJ, 08543, US

(21) Appl. No.: 10/583,707

(22) PCT Filed: Dec. 21, 2004
(86) PCT No.: PCT/US2004/043266

§ 371 Date: Jun. 20, 2006

Related U.S. Application Data
(60) Provisional application No. 60/532,228, filed on Dec. 23, 2003.

(51) Int. Cl. H04N 5/50

(52) U.S. Cl. 348/731; 348/E05.097

(57) ABSTRACT

An apparatus and a method for selecting one of a plurality of digital video channels and analog video channels in response to user selection, in particular, when operating in a digital recording mode. The user may select the channel using either a channel scan mode, in which the user selection causes the selection of the next channel in a channel sequence, or a direct channel mode, in which the user enters a specific channel number to be selected. When operating in the recording mode, and the apparatus receives a channel selection in the channel scan mode, the apparatus selects the next digital channel in the sequence and skips any intervening analog channels. When the operating in the recording mode, and the apparatus receives a channel selection in the direct channel selection mode, the apparatus selects the channels and terminates the recording mode if the selected channel is an analog channel and maintains the recording mode if the selected channel is a digital channel. The invention also provides a method for controlling the content in the buffer of a storage device as the user scans through major and minor television channels.

This U.S. non-provisional patent application claims the benefit of U.S. provisional patent application Ser. No. 60/532,228, filed Dec. 23, 2003, entitled “Method and Apparatus for Changing Channels in a System Operating in a PVR Mode.”

### FIELD OF THE INVENTION

This invention relates to a method and an apparatus for selecting one of a plurality of digital video channels and analog video channels in response to user selection. The user selection may correspond to a channel selection command using a channel scanning mode or a direct channel selection mode and may be received during a recording operation of the system.

### BACKGROUND OF THE INVENTION

In video broadcast and processing applications, digital and/or analog video signals are transmitted and received on predetermined video signal channels. The term digital video channel as used herein refers to a signal channel used for transmitting digital video signals, for example, video signals encoded in accordance with MPEG-2 (ISO/IEC 13818-1/2). The term analog video channel as used herein refers to a signal channel used for transmitting analog video signal, for example, video signals that comply with the NTSC standard.

In a traditional analog system such as those that comply with NTSC, a video channel occupies a 6 MHz bandwidth and the corresponding program signals associated with the signal channel are carried within this bandwidth. By contrast, in digital systems, the 6 MHz bandwidth may be used to carry several sub-channels, each carrying its own program signals. The division of the bandwidth is enabled by time multiplexing transport streams that carry the program signals associated with the various sub-channels. The concept of sub-channels is further described herein. Additionally, the allocation of the bandwidth may be dynamically changed to accommodate changing broadcast programming requirements.

A television receiver generally allows a user to select a channel using at least two modes, a channel scan mode and a direct channel selection mode. In the channel scan mode, the receiver selects, or tunes, to the next signal channel in the list of available video channels in response to a channel up or channel down command. The list of available video channels may correspond to a simple listing of the channels along the frequency spectrum or may be otherwise determined. The channel scan list may be any list of channels that are designated for sequential selection, or tuning, for example, but not limited to, a list of favorite channels designated by the user, or a list of recommended generated within an electronic program guide. A channel scan operation may automatically tune to channels in the list for a predetermined period of time in a sequential manner, in which the sequential tuning continues until the user selects a particular channel. In a system that includes digital video channels and analog video channels, the type of channels selected may alternate in response to the channel scan commands. In the direct channel selection mode, the receiver selects, or tunes, to a specific channel number in response to user entry of the channel number.

Generally it is highly desirable to be able to record the digital television broadcast because of the high picture quality, widescreen aspect ratio and high audio quality associated with such broadcasts. However, recording digital television broadcasts (ATSC, QAM) is not possible using a conventional VCR since they do not include a built-in digital tuner. It may be possible to record the digital television broadcasts using digital storage devices, such as an audio/video hard disk drive (“AVHDD”). Because of its ability to capture and effortlessly manipulate digital video, an AVHDD enables a user to exercise great control over the playback of a program. Devices that utilize such hard disk drives to record television programs, often referred to as a personal video recorder (PVR) or digital video recorder (DVR), have recently become popular. In such devices, the received video signal is continuously stored onto a buffer to enable a user to manipulate the received video signal at any time, i.e. pause, replay, skip, etc.

Current DVR devices generally receive and record video signals that have been processed by the receiving device, usually in analog form. It would be desirable to provide a method and an apparatus that allows direct recording of the received digital video signals. However, such a system presents several challenges including: how to handle channel changing during a recording mode when the user selects an analog channel; how to handle channel changes within a channel that includes sub-channels, referred to as “minor” channels by ATSC; and how to handle the buffer that is used to store the video signals upon channel changes, particularly when PID filtering is enabled. The present invention addresses these issues and provides a method and an apparatus for handling them.

### SUMMARY OF THE INVENTION

The present invention provides a method and apparatus for connecting a digital storage device to a television apparatus, via a digital bus, to enable the digital storage device to store received program data, to thereby provide PVR functions. The television apparatus may operate in a recording mode upon user selection of a digital video channel or upon user selection of a predetermined key or set of keys on the remote control. The present invention provides for handling the storage of the program data in an environment comprising a plurality of digital video channels and a plurality of analog video channels. The digital video channels may include a plurality of sub-channels and may be designated using major and minor channel numbers. In an alternative embodiment, the digital storage device may be included within the television apparatus.

Specifically, the present invention provides a method for controlling a television apparatus, comprising the steps of: selecting one of a plurality of digital video channels and analog video channels in response to user input corresponding to a channel selection command using one of a channel scan mode and a direct channel selection mode; transferring, via a digital bus, a program signal received via a selected digital video channel to a storage device while in a digital recording mode; selecting a new one of the plurality of digital video channels and analog video channels in response to the user input while in the digital recording mode, wherein if the channel scan mode is used, selecting a next digital video channel in the channel scan sequence and skipping any intervening analog video channels between a currently selected video channel and the next digital video channel in the channel scan sequence, and maintaining the digital recording mode. Further, the method comprises, if the user input uses the direct channel selection mode, and the selected channel corresponds to an analog video channel, selecting the analog video channel and terminating the digital recording mode, and if the selected channel corresponds to a digital video channel, selecting the digital video channel and maintaining the digital recording mode.

The invention also provides an apparatus, comprising: means for receiving a user input including channel selection commands using one of a channel scan mode and a direct channel mode; means for selecting one of a plurality of digital video channels and analog video channels in response to the channel selection commands, and for acquiring program signals associated with the selected one of the video channels; means for transferring, via a digital bus, a selected program signal to a storage device when the apparatus is in a recording mode; and means, coupled to the receiving means, selecting means and transferring means, for controlling the operation of the apparatus in response to user input, wherein if a received channel selection command uses the channel scan mode, the selecting means selects a next digital video channel in a channel scan sequence and skips any intervening analog video channel between a currently selected video channel and the next digital video channel, and maintaining the digital recording mode. Further, the apparatus comprises, wherein if a received channel selection command uses the direct channel selection mode, and the selected channel corresponds to an analog video channel, the selecting means selects the analog video channel and terminates the digital recording mode, and if the selected channel corresponds to a digital video channel, the selecting means selects the digital video channel and the apparatus maintains the digital recording mode.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a simplified block diagram of an exemplary television system and storage device in which the present invention may be embodied;

FIG. 2 is a block diagram illustrating the use of an IEEE 1394 compliant cable/satellite box as a TV tuner;

FIG. 3 is a block diagram illustrating the use of an IEEE 1394 compliant cable/satellite box in a PVR mode in accordance with the principles of the present invention;

FIG. 4 is a block diagram illustrating the use of an IEEE 1394 compliant cable/satellite box in PVR mode as the TV tuner in accordance with the principles of the subject invention; and

FIG. 5 is a flowchart of an exemplary manner of operation of the present invention.

Corresponding reference characters indicate corresponding parts throughout the several views. The exemplifications set out herein illustrate various embodiments of the invention, but such exemplifications are not to be construed as limiting the scope of the invention in any manner.

### DETAILED DESCRIPTION

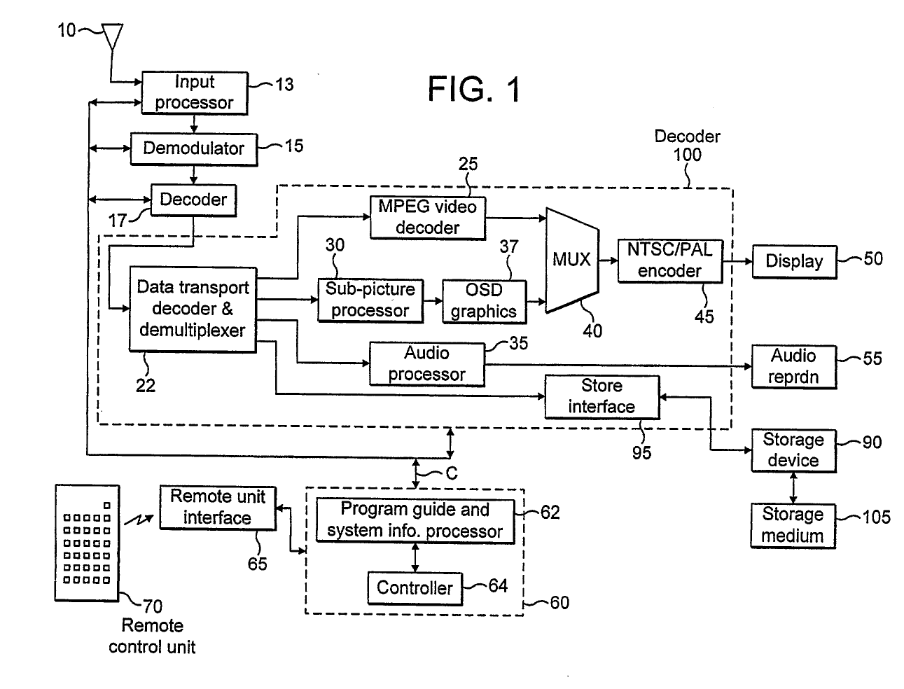

FIG. 1 is a block diagram of a digital video receiving system for demodulating and decoding broadcast signals, according to the principles of the invention. Although the disclosed system is described in the context of a system for receiving video signals transmitted in digital video channels and analog video channels, it is exemplary only. The digital video signals may be of a variety of types. For example, it may comply with the high definition television (HDTV) signal standard Digital Television Standard for HDTV Transmission of Apr. 12, 1995, prepared by the United States Advanced Television Systems Committee (ATSC) or other ATSC standards. Alternatively, it may be formed in accordance with proprietary or custom requirements of a particular system.

The principles of the invention may be applied to terrestrial, cable, satellite, Internet or computer network broadcast systems in which the coding type or modulation format may be varied. Such systems may include, for example, non-MPEG compatible systems, involving other types of encoded datastreams and other methods of conveying program specific information. Further, although the disclosed system is described as processing broadcast programs, this is exemplary only. The term ‘program’ is used to represent any form of packetized data such as audio data, telephone messages, computer programs, Internet data or other communications, for example.

In overview, in the video receiver system of FIG. 1, a broadcast carrier modulated with signals carrying audio, video and associated data representing broadcast program content is received by antenna 10 and processed by unit 13. The resultant digital output signal is demodulated by demodulator 15. The demodulated output from unit 15 is trellis decoded, mapped into byte length data segments, deinterleaved and Reed-Solomon error corrected by decoder 17. The corrected output data from unit 17 is in the form of an MPEG compatible transport datastream containing program representative multiplexed audio, video and data components. The transport stream from unit 17 is demultiplexed into audio, video and data components by unit 22, which is further processed by the other elements of decoder system 100. In one mode, decoder 100 provides MPEG decoded data for display and audio reproduction on units 50 and 55 respectively. In a recording mode, the transport stream from unit 17 is processed by decoder 100 to provide an MPEG compatible datastream for storage on storage medium 105 via storage device 90. Such a system is known, for example, from RCA ATC32X HDTV receivers manufactured by Thomson Inc., of Indianapolis, Ind.

In the exemplary embodiment, the connection between store interface 95 and storage device 90 is via an IEEE 1394 connection. The IEEE 1394 connection is a well-known digital data bus and allows for transferring the digital data between the television receiver and the storage device 90. Other suitable digital data busses may be used, including, but not limited to, USB, Ethernet, etc. The storage device 90 is an AVHDD device having one or more hard disks therein for storing the video data. The storage device 90 includes a temporary buffer for storing currently received video data for providing PVR related functions. The temporary buffer is filled and emptied as described below. Other suitable storage devices may also be used, including, but not limited to, solid state memories, rewritable optical disks, etc. In the exemplary embodiment, the storage device 90 is a separate element that is connected to the television receiver via a digital bus. In an alternative embodiment, the storage device may be included as part of the television receiver.

In the exemplary embodiment, the apparatus enters the recording mode upon user selection of a digital video channel. When it is in the recording mode, the received video data is automatically stored in a buffer in storage device 90 as the video data is being received. The television receiver may then process and display the video data from the buffer in response to user commands, to thereby provide PVR related functions such as pausing, fast forwarding, rewind, of the currently received video. The recording mode may be entered using alternative methods, for example, in response to user activation of a record key on remote control unit 70, or user selection of designated keys on the remote control unit 70, for example the transport keys (Pause, slow, FF, rewind, instant replay, etc.)

A user selects for viewing either a TV channel or an on-screen menu, such as a program guide, by using a remote control unit 70. Processor 60 uses the selection information provided from remote control unit 70 via interface 65 to appropriately configure the elements of FIG. 1 to receive a desired program channel for viewing. Processor 60 comprises processor 62 and controller 64. Unit 62 processes (i.e. parses, collates and assembles) program specific information including program guide and system information and controller 64 performs the remaining control functions required in operating decoder 100. Although the functions of unit 60 may be implemented as separate elements 62 and 64 as depicted in FIG. 1, they may alternatively be implemented within a single processor. For example, the functions of units 62 and 64 may be incorporated within the programmed instructions of a microprocessor. Processor 60 configures processor 13, demodulator 15, decoder 17 and decoder system 100 to demodulate and decode the input signal format and coding type. Units 13, 15, 17 and sub-units within decoder 100 are individually configured for the input signal type by processor 60 setting control register values within these elements using a bi-directional data and control signal bus C.

The transport stream provided to decoder 100 comprises data packets containing program channel data and program specific information. Unit 22 directs the program specific information packets to processor 60, which parses, collates and assembles this information into hierarchically arranged tables. Individual data packets comprising the user selected program channel are identified and assembled using the assembled program specific information. The program specific information contains conditional access, network information and identification and linking data enabling the system of FIG. 1 to tune to a desired channel and assemble data packets to form complete programs.

Considering FIG. 1 in detail, a carrier modulated with signals carrying program representative audio, video and associated data received by antenna 10, is converted to digital form and processed by input processor 13. Processor 13 includes radio frequency (RF) tuner and intermediate frequency (IF) mixer and amplification stages for down-converting the input signal to a lower frequency band suitable for further processing. In this exemplary system, the input signal received by antenna 10 contains 33 Physical Transmission Channels (PTCs 0-32). Each Physical Transmission Channel (PTC) is allocated a 6 MHz bandwidth and contains, for example, up to 6 sub-channels.

It is assumed for exemplary purposes that a video receiver user selects a sub-channel (SC) for viewing using remote control unit 70. Processor 60 uses the selection information provided from remote control unit 70 via interface 65 to appropriately configure the elements of decoder 100 to receive the PTC corresponding to the selected sub-channel SC. Following down conversion, the output signal from unit 13 for the selected PTC has a bandwidth of 6 MHz and a center frequency in the range of 119-405 MHz. In the following discussion, an RF channel or Physical Transmission Channel (PTC) refers to an allocated broadcaster transmission channel band, which encompasses one or more sub-channels (also termed virtual or logical channels).

Processor 60 configures the radio frequency (RF) tuner and intermediate frequency (IF) mixer and amplification stages of unit 13 to receive the selected PTC. The down-converted frequency output for the selected PTC is demodulated by unit 15. The primary functions of demodulator 15 are recovery and tracking of the carrier frequency, recovery of the transmitted data clock frequency, and recovery of the video data itself. Unit 15 also recovers sampling and synchronization clocks that correspond to transmitter clocks and are used for timing the operation of processor 13, demodulator 15 and decoder 17. The recovered output from unit 15 is provided to decoder 17.

The output from demodulator 15 is mapped into byte length data segments, deinterleaved and Reed-Solomon error corrected according to known principles by unit 17. In addition, unit 17 provides a Forward Error Correction (FEC) validity or lock indication to processor 60. Reed-Solomon error correction is a known type of Forward Error Correction. The FEC lock indication signals that the Reed-Solomon error correction is synchronized to the data being corrected and is providing a valid output. It is to be noted that the demodulator and decoder functions implemented by units 13, 15 and 17 are individually known and generally described, for example, in the reference text Digital Communication, Lee and Messerschmidt (Kluwer Academic Press, Boston, Mass., USA, 1988).

The corrected output data from unit 17 is processed by MPEG compatible transport processor and demultiplexer 22. The individual packets that comprise either particular program channel content, or program specific information, are identified by their Packet Identifiers (PIDs). Processor 22 separates data according to type based on an analysis of Packet Identifiers (PIDs) contained within packet header information and provides synchronization and error indication information used in subsequent video, audio and data decompression.

The corrected output data provided to processor 22 is in the form of a transport datastream containing program channel content and program specific information for many programs distributed through several sub-channels. The program specific information in this exemplary description describes sub-channels present in a transport stream of a particular PTC. However, in another embodiment the program specific information may also describe sub-channels located in other PTCs and conveyed in different transport streams. Groups of these sub-channels may be associated in that their source is a particular broadcaster or they occupy the transmission bandwidth previously allocated to an analog NTSC compatible broadcast channel. Further, individual packets that comprise a selected program channel in the transport stream are identified and assembled by processor 60 operating in conjunction with processor 22 using PIDs contained in the program specific information.

Currently an analog video channel and a digital video channel are allocated to each broadcaster. All of the analog video channels are located together at one end of the frequency spectrum and the digital video channels are located together at another end of the frequency spectrum. However, the sequential ordering of the channels may be determined by the television receiver manufacturer. For example, it is possible that during a channel scan operation, all of the analog video channels are scanned first then followed by the digital video channels. Alternatively, the channels may be scanned according to the broadcaster, for example, the digital video channels for the broadcaster are scanned after the analog video channel associated with that broadcaster.

As noted above, the digital video channel may be divided into sub-channels by the broadcaster. In that case, the sub-channels are designated by their respective major and minor channel numbers, wherein the first channel number, or major channel number, refers to the broadcaster, and the second channel number, or minor channel number, refers to the sub-channel number within the digital video channel. For example, a broadcaster in New York City may use a major channel number 5, and have sub channels 5-1 to 5-4 within its allocated digital video channel. A channel, or sub-channel, which may have major and minor channel numbers associated therewith, and are multiplexed with other digital video channels are often referred to as a virtual channel. During a channel scan operation, the television receiver generally scans through each of the minor channels within the major channel before reaching the channels associated with the next major channel.

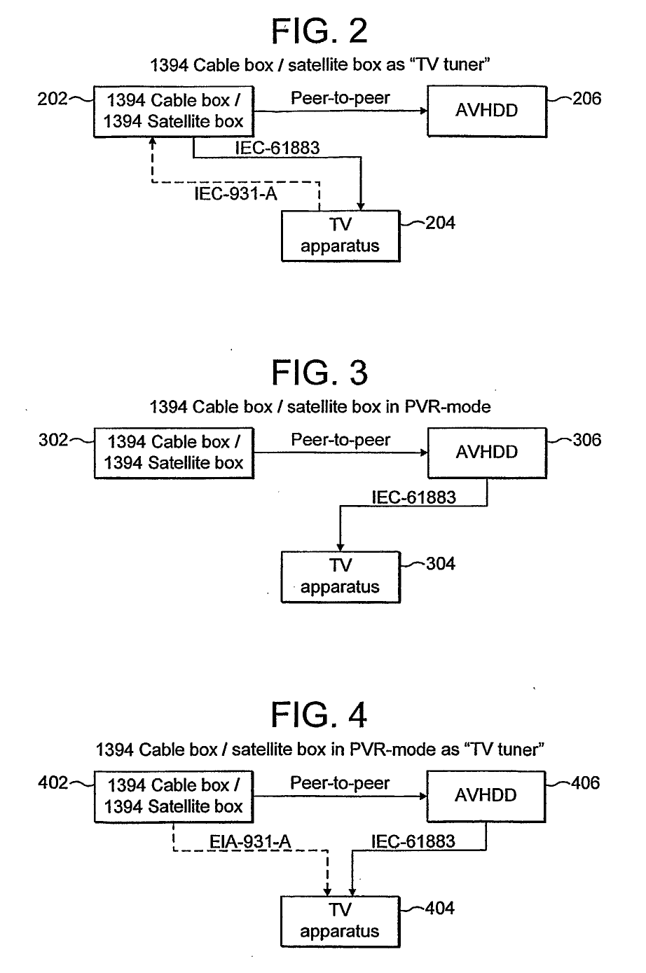

FIGS. 2-4 show additional configurations suitable for use with the present invention wherein a television receiver apparatus is coupled to an AVHDD for recording program data received by the television apparatus.

FIG. 2 illustrates a situation where the cable/satellite box 202 is the TV tuner (digital content input source). The television apparatus 204 establishes a peer-to-peer connection between the IEEE 1394 compliant cable/satellite box 202 and an AVHDD 206. The EIA-931-A arrow represents the IEEE 1394 connection, and the IEC-61883 arrow represents the audio/video equipment digital interface protocol.

FIG. 3 illustrates the situation where the cable/satellite box 302 is the TV digital content input source in the PVR mode. The television apparatus 304, in accordance with the present principles establishes a peer-to-peer connection between the IEEE 1394 compliant cable/satellite box 302 and an AVHDD 306. The IEC-61883 arrow represents the audio/video equipment digital interface protocol between the AVHDD 306 and the television apparatus 304.

FIG. 4 illustrates the situation where the cable/satellite box 402 is the TV tuner (digital content input source) in the PVR mode. The television apparatus 404, in accordance with the present principles establishes a peer-to-peer connection between the IEEE 1394 compliant cable/satellite box 402 and an AVHDD 406. The IEC-61883 arrow represents the audio/video equipment digital interface protocol between the AVHDD 406 and the television apparatus 404. The EIA-931-A arrow represents the IEEE 1394 connection between the television apparatus 404 and the cable/satellite box 402.

As discussed herein, recording operation refers to operation whereby a television signal receiver, which may include a cable or satellite set top box, transfers and stored in a buffer of a connected, or integral, storage device, program signals received from a selected video channel. A problem may exist in performing a recording operation during a channel change when an analog video channel is selected because the television receiver may not have an MPEG encoder included therein. Where the television receiver does not include an MPEG encoder, the television is unable to transfer the digital video data to the storage device to enable PVR functions. In accordance with the present invention, if the television receiver is operating in the recording mode, i.e., transferring the received video data to a buffer in the storage device via the digital bus, and a channel scan command is received, the television receiver tunes to the next digital video channel, skipping any intervening analog video signals. Also, if the television receiver is operating in the recording mode and a direct channel selection command is received, wherein the selected channel is an analog channel, the television receiver terminates the recording operation and tunes to the selected analog video channel. If the selected channel is a digital channel, the television receiver selects the channel and continues the recording operation.

A further issue in the above system is the handling of channel changes in the context of major and minor channels while in the recording mode. While receiving and processing sub-channels within the major channels, PID filtering may be enabled or disabled. If PID filtering is enabled, only the packets associated with a selected sub-channel is selected, therefore a smaller amount of data needs to be stored in the buffer. If PID filtering is disabled, all of the data packets associated with the digital video channel is stored in the buffer. In accordance with the present invention, when the selected channel is another minor channel within the current major channel, and PID filtering is enabled, the temporary buffer is emptied and the new channel is selected, otherwise the temporary buffer is not emptied before the new channel is selected, which allows the user to review stored program data from a previous sub-channel. If the selected channel is a sub-channel in a new major channel, the temporary buffer is always emptied before the new channel is selected. In an exemplary embodiment, PID filtering may be selectively enabled by the user. Alternatively, the PID filtering may be set, to a default status, by the television receiver, wherein the user may override the default status as desired.

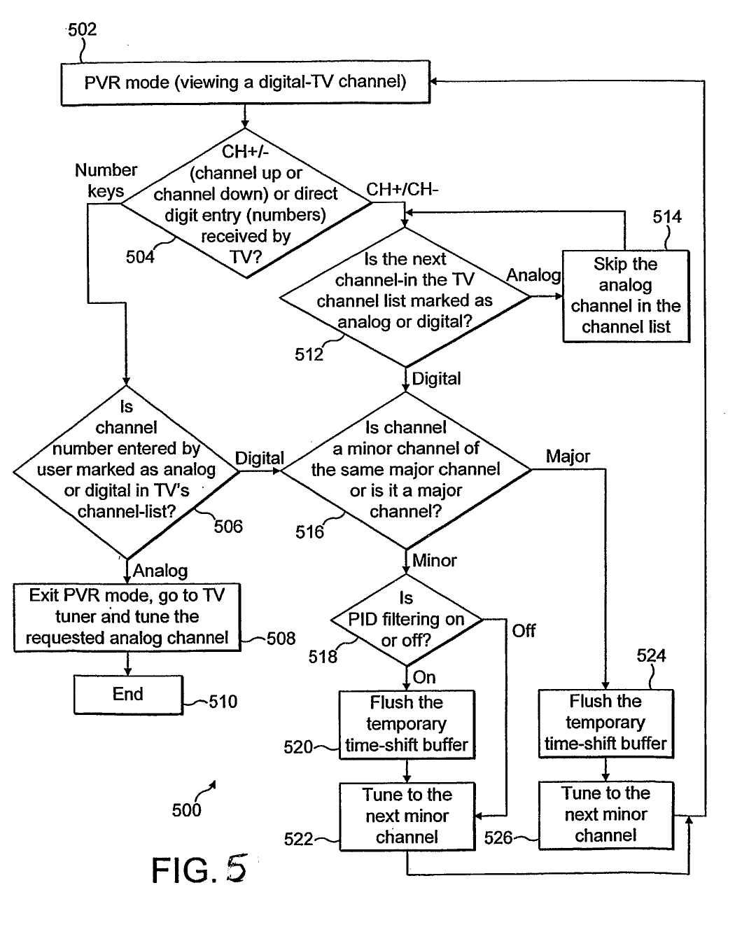

FIG. 5 is a flowchart showing the steps associated with a method according to the present invention. Method 500 includes step 502 wherein the apparatus is operating in a recording, or PVR mode, when a digital video channel is selected for viewing. In this mode, the received video signal is continuously transferred to the storage device and the television apparatus awaits a channel change command.

Upon receiving a channel change command in step 504, it is determined whether the channel change command is in the form of a channel up or channel down command, i.e., a channel scan command, or a direct channel selection command. If the channel change command is in the form of a direct channel selection command, the method proceeds to step 506 where it is determined whether the selected channel is an analog video channel or a digital video channel. If the selected channel is an analog video channel, the method proceeds to step 508, wherein the recording mode is terminated, the apparatus tunes to the selected channel, and processes the received analog video signals.

If the selected channel is a digital video channel, the method proceeds to step 516 where it is determined whether the selected channel is a minor channel of the same major channel or whether it is a minor channel of a new major channel. If the former, the method proceeds to step 518 where it is determined whether PID filtering is ON or OFF. If PID filtering is ON, the temporary time-shift buffer is emptied in step 520 and the selected next minor channel is selected in step 522. If PID filter is OFF, the selected next minor channel is selected in step 522 without emptying the temporary time-shift buffer.

If it is determined in step 516 that the selected channel is a new minor channel of a new major channel, the method proceeds to step 524 where the temporary time-shift buffer is emptied and to step 526 where the selected channel is tuned. The method then returns to step 502 and continues the recording mode.

If it is determined in step 504 that the channel change command is a channel scan command, that is a channel up or channel down command, the method proceeds to step 512 where it is determined whether the next channel in the channel list is an analog video channel or a digital video channel. If the next channel is an analog video channel, the method skips the analog video channel, and any other intervening analog video channels and tunes to the next digital video channel in step 514. If the next channel is a digital video channel, the method proceeds to step 516 and continues as described above.

1. A method for controlling a video signal processing apparatus, comprising the steps of:
selecting a first video channel from a plurality of video channels including digital video channels and analog video channels in response to user input corresponding to a channel selection command using one of a channel scan mode and a direct channel selection mode;
transferring a program signal received via a selected digital video channel to a storage device in response to activation of a digital recording mode;
selecting a new one of the plurality of digital video channels and analog video channels in response to the user input while in the digital recording mode, wherein
if the channel scan mode is used, selecting a next digital video channel in the channel scan sequence and skipping any intervening analog video channels between a currently selected video channel and the next digital video channel in the channel scan sequence, and maintaining the digital recording mode.

2. The method according to claim 1, wherein if the user input uses the direct channel selection mode, and the selected channel corresponds to an analog video channel, selecting the analog video channel and terminating the digital recording mode, and if the selected channel corresponds to a digital video channel, selecting the digital video channel and maintaining the digital recording mode.

3. The method according to claim 2, wherein the digital recording mode is initiated in response to user selection of predetermined keys on a user input device.

4. The method according to claim 2, wherein the digital recording mode is initiated in response to user selection of a digital video signal channel.

5. The method according to claim 2, wherein the program signal is stored in a designated buffer in the storage device.

6. The method according to claim 5, wherein the storage device comprises a hard disk device coupled to the television apparatus via the IEEE 1394 bus.

7. The method according to claim 5, wherein the digital video channels are designated by respective major and minor channel numbers, and wherein if the newly selected video channel corresponds to a sub-channel having a new major channel number, deleting any program signals stored in the designated buffer.

8. The method according to claim 5, further comprising the step of determining whether PID filtering is enabled, and if so, deleting any program signals stored in the designated buffer upon selection of a new digital video channel.

9. The method according to claim 5, further comprising the step of determining whether PID filtering is enabled, and if not, and wherein the digital video channels are designated by respective major and minor channel numbers, deleting any program signals stored in the designated buffer only when the newly selected digital video channel corresponds to a sub-channel having a new major channel number.

10. An apparatus, comprising:
means for receiving a user input including channel selection commands using one of a channel scan mode and a direct channel mode;
means for selecting one of a plurality of digital video channels and analog video channels in response to the channel selection commands, and for acquiring program signals associated with the selected one of the video channels;
means for transferring, via a digital bus, a selected program signal to a storage device when the apparatus is in a recording mode; and
means, coupled to the receiving means, selecting means and transferring means, for controlling the operation of the apparatus in response to user input, wherein if a received channel selection command uses the channel scan mode, the selecting means selects a next digital video channel in a channel scan sequence and skips any intervening analog video channel between a currently selected video channel and the next digital video channel, and maintaining the digital recording mode.

11. The apparatus according to claim 10, wherein if a received channel selection command uses the direct channel selection mode, and the selected channel corresponds to an analog video channel, the selecting means selects the analog video channel and terminates the digital recording mode, and if the selected channel corresponds to a digital video channel, the selecting means selects the digital video channel and the apparatus maintains the digital recording mode.

12. The apparatus according to claim 11, wherein the controlling means initiates the digital recording mode in response to user selection of predetermined keys on a user input device.

13. The apparatus according to claim 11, wherein the controlling means initiates the digital recording mode in response to user selection of a digital video signal channel.

14. The apparatus according to claim 11, wherein the program signal is stored in a designated buffer in the storage device.

15. The apparatus according to claim 11, wherein the storage device comprises a hard disk device coupled to the television apparatus via the IEEE 1394 bus.

16. The apparatus according to claim 15, wherein the digital video channels are designated by respective major and minor channel numbers, and wherein if the newly selected video channel corresponds to a sub-channel having a new major channel number, the control means causes the storage device to delete any program signals stored in the designated buffer.

17. The apparatus according to claim 15, wherein the controlling means determines whether PID filtering is enabled, and if so, causes the storage device to delete any program signals stored in the designated buffer upon selection of a new digital video channel.

18. The apparatus according to claim 15, wherein the controlling means determines whether PID filtering is enabled, and if not, and wherein the digital video channels are designated by respective major and minor channel numbers, causes the storage device to delete any program signals stored in the designated buffer only when the newly selected digital video channel corresponds to a sub-channel having a new major channel number.
